(19) United States
(12) Patent Application Publication
(10) Pub. No.: US 2009/0026832 A1
(43) Pub. Date: Jan. 29, 2009

(54) Wheel Comprising a Protection Ring for the Rim Flange

(76) Inventor: Heinrich Baumgartner, Schiltach (DE)

Correspondence Address: WOOD, PHILLIPS, KATZ, CLARK & MORTIMER, 500 W. MADISON STREET, SUITE 3800, CHICAGO, IL, 60661, US

(21) Appl. No.: 11/885,198

(22) PCT Filed: Feb. 28, 2006
(86) PCT No.: PCT/EP2006/001828

§ 371 Date: Sep. 11, 2008

(30) Foreign Application Priority Data
Feb. 28, 2005 (DE) 10 2005 009 594.1

(51) Int. Cl. B60B 7/01; B60B 1/14

(52) U.S. Cl. 301/37.24; 977/890

(57) ABSTRACT

The invention relates to a wheel (1), in particular a light-alloy wheel for motor vehicles, consisting essentially of a rim (2) and wheel spokes (3), the entire periphery of the outer rim flange (15) being provided with a rim-flange protection ring (10). A cavity (71) is formed between the outer rim flange (15) or the outer rim base (9) and the rim-flange protection ring (10), said cavity being suitable for receiving additional engineered elements. The rim-flange protection ring (10) also acts as a protective element in a collision.

The present invention refers to a wheel, in particular a light-alloy wheel for motor vehicles in accordance with the preamble of claim 1.

Such wheels are composed of rim and wheel spokes, in a known manner. Particularly for high-quality wheels, which are generally manufactured from light alloys, the outer rim flange is arranged as a so-called “soft flange,” which, especially for wheels with large diameters, is frequently damaged by contact with curbs. Even if the wheel is not thereby impaired in its operational reliability, the overall visual picture suffers.

As such, for example in WO 93/07012 or WO 96/07554, the proposal was to provide the wheel with a rim-flange protection ring, which can be replaced in the event of damage. The rim-flange protection ring thereby essentially rests on the entire surface of the outer rim flange and is held by fastening elements or a layer of glue. Moreover, with wheels that are arranged in multiple parts, it is possible to clamp the rim-flange protection ring between the rim and/or the outer rim base and the wheel spokes and/or the wheel disk.

Although, in practice such wheels have worked satisfactorily, there is still a need for further improvement in the visual appearance. For example, if the arrangement within the area of the outer rim base is to be retained, there is often criticism that the tire inflation valve prevents the perfect symmetry that is desired.

There is an additional problem with high-quality wheels in connection with balancing weights. Visual reasons prohibit attaching these to the outer rim flange, as this is typical for conventional steel wheels. Therefore, the weights are frequently attached in a radial and axial direction to locations lying further inside (for example, within the area of the drop center), and, in such manner, are removed from the direct field of vision. Compared to mounting on the outer rim flange, such positions require larger dimensions in order to obtain the same balancing effect.

For conventional wheels made of steel with a conventionally designed outer rim flange, in U.S. Pat. No. 5,273,345, there is a proposal, caused by the design for a steel wheel, for enclosing an emerging circulating channel between the wheel disk and the outer rim flange for the visual upgrading of the wheel through a ring. The ring is thereby held by several spring steel clips that are distributed over the area and are clipped to the outer rim flange. Additionally, through the described ring, the balancing weights (which are likewise fastened by clips to the outer flange and are found in the circulating channel) are enclosed. A function that goes beyond the simple enclosure of the channel and the balancing weights (for example, a protective function for the rim-flange) is thereby not achievable and, based on the design of the rim, is also not necessary.

Therefore, the present invention underlies the problem of improving wheels of the type initially specified in such a manner that the described disadvantages no longer arise.

In particular, as a rule, the outer rim flange, arranged as a soft flange, should continue to remain protected against direct damages from contacts with curbs by the rim-flange protection ring, but, at the same time, should achieve a further improvement of the overall visual picture of the wheel.

This problem is solved with the characteristics of claim 1.

Advantageous forms of embodiments are described by the characteristics of the subclaims.

The invention underlies the idea of modifying the rim-flange protection ring and the outer rim base with the outer rim flange in such a way that, in addition to the protective effect for the outer rim flange, an enclosure of all elements is possible, which would have to be arranged in the area of the outer rim base and, in this respect, would make perfect symmetry impossible.

This is specifically successful in the fact that, between the rim-flange protection ring and the outer rim base, a cavity is formed in which the activated elements are arranged and/or can be arranged. The cavity is purposefully formed in a circulating manner (for example, by indentations, recesses, shoulder or channels) in the outer rim base, such that technical elements (such as, for example, balancing weights, valves or devices for tire pressure control) are able to be attached therein. As previously, the rim-flange protection ring can be attached to the upper, outgoing end of the outer rim flange and would thereby further protect this. Directed in a manner that is radially and/or axially inward, the rim-flange protection ring is formed in such a way that it encloses the technical elements. At the furthest of its end that is directed radially inward, it is introduced along the outer side of the outer rim base, such that a cavity is formed between the rim-flange protection ring and the outer side of the outer rim base.

Depending upon the requirement, the cavity can be provided in an axial direction (for example, for incorporating balancing weights) and/or in a radial direction (for example, for mounting a tire inflation valve or a device for tire pressure control).

The cavity can be essentially arranged as a closed cavity, wherein the technical elements are particularly well protected against environmental influences. This plays an important role particularly for sensitive elements (such as, for example, sensors or signal transmission units for tire pressure control).

One cost-effective implementation of the concept arises if the rim-flange protection ring is essentially arranged in an L-shape in the cross-section. The two journals permit an enclosure in the axial and the radial direction, wherein a flat overall picture that is frequently aesthetically perceived can be obtained.

Substantial importance is also attached to the fastening mechanism for the rim-flange protection ring. Specifically, it should ensure good accessibility of the elements arranged under it. This is particularly important for the arrangement of a tire inflation valve in the cavity. It is preferred that fastening elements that make possible a clip or a catch connection are selected. In the specific implementation, catch noses (also, circulating catch noses, corresponding grooves, lock washers or other actually known elements) are preferred.

For wheels that are arranged in multiple parts, the rim-flange protection ring can be clamped between the rim and the wheel spokes. This variant makes access to the elements that are arranged in the cavity more difficult, but this is preferred in terms of theft security for certain applications.

Finally, it is also possible to secure the rim-flange protection ring to the outer rim base or otherwise by means of a layer of glue or additional fastening bolts.

Advantageous embodiments are based on the fact that different types of fastening are combined.

As material for the rim-flange protection ring, a multitude of materials is applicable. In addition to plastic, metals (such as high-grade steel, titanium, aluminum or magnesium) or, in addition, carbon fiber-reinforced plastics and/or glass fiber-reinforced plastics or composite materials made of metal and plastic can be applied. Likewise, an enclosure with a combination of the materials mentioned with natural materials (e.g., laminates made of wood) is conceivable.

With relative cost effectiveness, ring-flange cover rings made of metal can be manufactured and afforded various visual effects through direct mechanical treatment (e.g., mirror finish through polishing). Ring-flange cover rings made of plastic or fiber-reinforced plastics and/or bonding materials can be arranged with particular resistance to impact and make possible a simple treatment of the surface area for obtaining special visual or other effects. Thus, particularly interesting visual effects can be obtained through dyeing or even metallic coatings.

In order to increase the abrasion resistance of the ring-flange cover ring, an additional coating with nanoparticles can be undertaken. Such coatings are available for all materials, even metals. Coatings that are particularly efficient are those with nanoparticles that are themselves made from material that is resistant to friction (such as, for example, alpha-aluminum oxide).

If visual effect is of primary importance, additional variations are available. Thus, the rim-flange protection ring can be provided and structured with additional design elements. One example of such a structuring is the fitting of the rim-flange cover ring with bolt mockups for simulating a bolt collar or other visually remarkable elements. As a whole, a multitude of design possibilities is available for the wheel, with which both technical and visual effects can be obtained. The rim-flange protection ring can also be arranged in such a way that additional areas of the wheel are covered radially in the direction of the wheel hub and/or wheel center.

In the following, the invention is described in detail on the basis of the example of an embodiment presented in the figures. The following is shown:

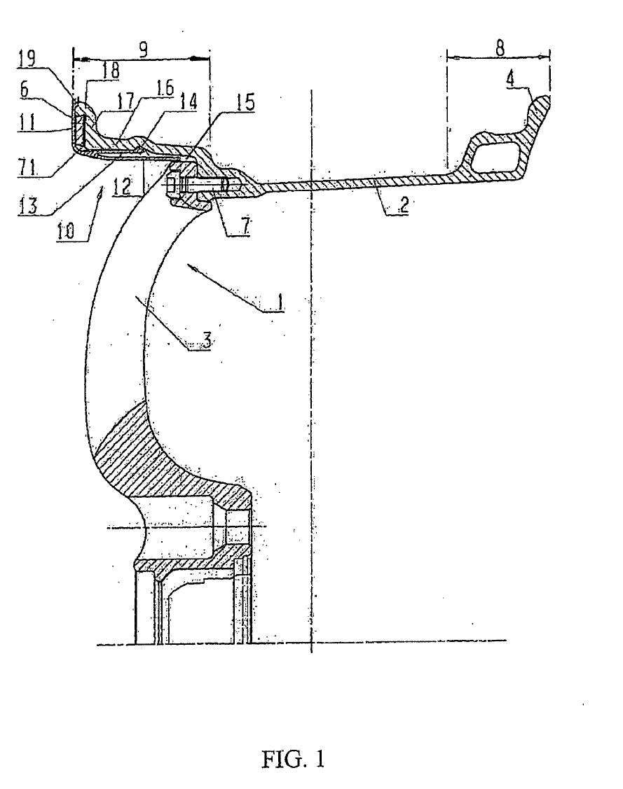

FIG. 1 is the cross-section of a first embodiment of the wheel according to the invention, with which a rim-flange protection ring is fastened by means of a simple clip connection;

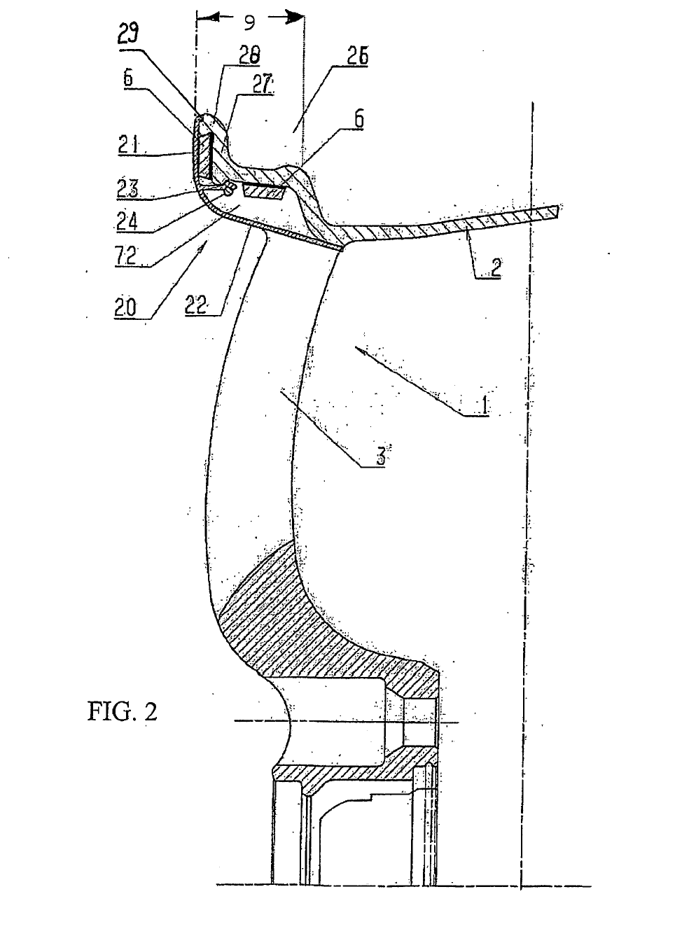

FIG. 2 is the cross-section of a second embodiment of the wheel according to the invention, with which a rim-flange protection ring is fastened with a lock washer by means of a clip connection;

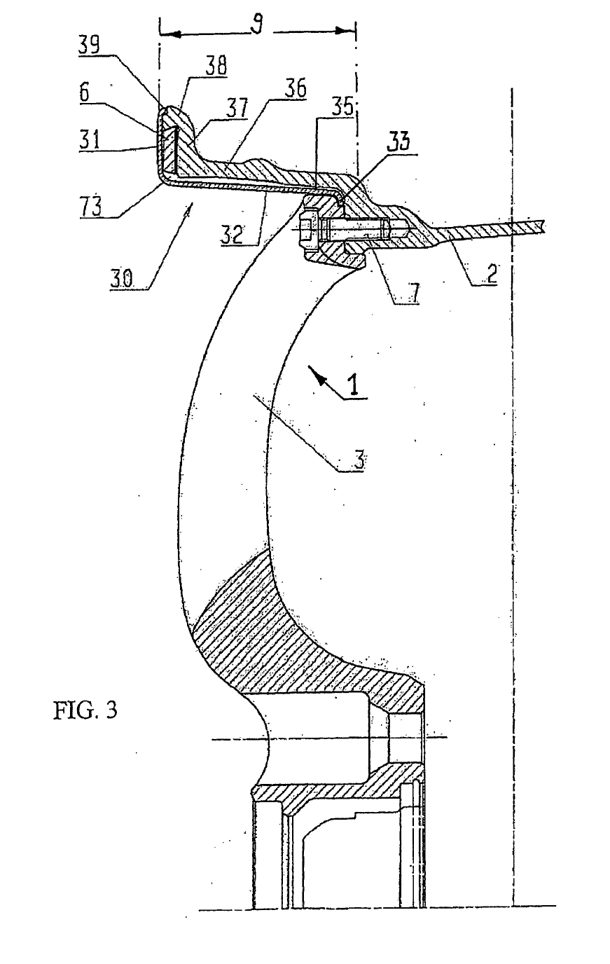

FIG. 3 is the cross-section of a third embodiment of the wheel according to the invention, with which a rim-flange protection ring is clamped between the outer rim flange and the wheel spokes;

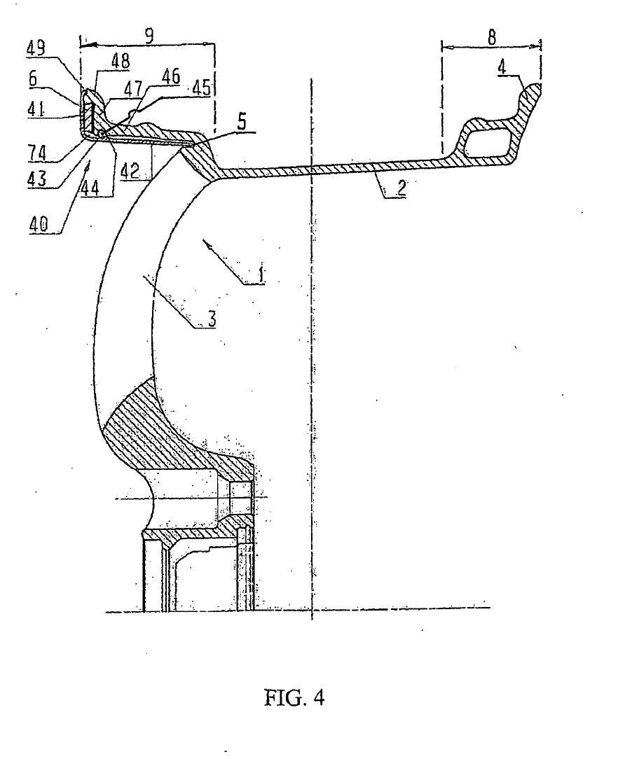

FIG. 4 is the cross-section of a fourth embodiment of the wheel according to the invention, with which a rim-flange protection ring catches on the outer rim base;

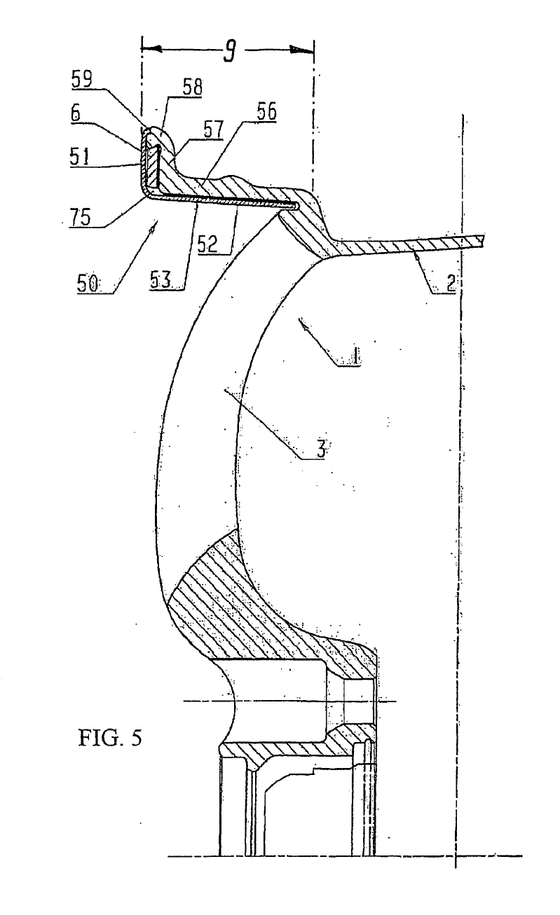

FIG. 5 is the cross-section of a fifth embodiment of the wheel according to the invention, with which the rim-flange protection ring is fastened to the outer rim base by means of an adhesive;

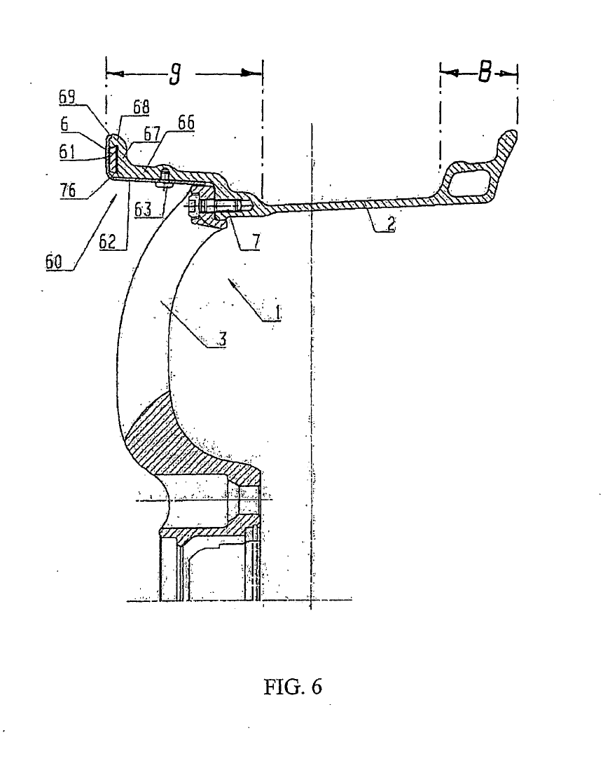

FIG. 6 is the cross-section of a sixth embodiment of the wheel according to the invention, with which the rim-flange protection ring is fastened to the outer rim base by means of bolts.

The fundamental structure of a wheel 1 is identical for the embodiments presented in FIGS. 1 to 6.

In a known manner, the wheel 1 is constructed from a rim 2 and wheel spokes 3. The rim 2 features an inner rim base 8 and an outer rim base 9. In an axial manner, each of these ends outward in an inner rim flange 4 and an outer rim flange 18, 28, 38, 48, 58, 68. Between inner rim flange 4 and outer rim flange 18, 28, 38, 48, 58, 68, a tire (not shown) is held, which sits on the inner rim base 8 and the outer rim base 9, and laterally from the inside, rests on the inner rim flange 4 and outer rim flange 18, 28, 38, 48, 58, 68.

The wheel 1 can be composed of one part, two parts or even multiple parts. For the one-part structure, rim 2 and wheel spokes 3 are manufactured from one piece, while, for the two-part structure, the rim 2 and the wheel spokes 3 are present as individual parts, which are bolted to one another upon the assembly of wheel 1. For multiple-part wheels, either the rim 2 or the wheel spokes 3 is arranged in multiple parts. Moreover, a combination made of the multiple parts of rim 2 and wheel spokes 3 is possible.

In FIG. 1, the wheel 1 is represented in a two-part arrangement. The rim 2 and the wheel spokes 3 are connected by fastening bolts 7. In an actually known manner, the rim 2 is arranged as a hump rim and exists in the area of the outer rim base 9 of a rim shoulder 16, which axially crosses over outwardly into a transition section 17, in order to finally end in an outer rim flange 18. Near the center of the rim shoulder 16, on its external side, the outer rim base 9 features a groove 14, which incorporates a fastening element 13 of a rim-flange protection ring 10. Additionally, at its outermost end, the outer rim flange 18 possesses a groove 19, in which the rim-flange protection ring 10 is in flush.

For this purpose, in the cross-section, the rim-flange protection ring 10 is constructed in an L-shaped manner, with two journals 11, 12 and nearly at right angles. The two journals 11, 12 effect the enclosure of the outer rim base 9 in an axial and radial direction. The radial enclosure is effected by the journal 12, which is spaced and nearly parallel to the rim shoulder 16. At its end, it is led between wheel spokes 3 and rim 2 in a recess 15.

The fastening to the outer rim base 9 is effected by a fastening element 13, which is formed in parallel to the journal 12, running along the rim-flange protection ring 10, and, at its end, features a nose, with which the fastening element 13 engages in a corresponding groove 14 of the rim shoulder 16.

The axial enclosure is effected by the journal 11, which runs parallel to and spaced from the transition area 17 and, at its end, supports the outer rim flange 18 in the groove 19. Thus, between the outer rim base 9 and the rim-flange protection ring 10, a cavity 71 is formed, in which a balancing weight 6 is incorporated. Thereby, the cavity 71 runs in an axial direction between the journal 11 and the transition section 17 and continues between the journal 12 and the rim shoulder 16.

The securing of the rim-flange protection ring 10 of this embodiment is effected by the fastening element 13, which locks into the groove 14 according to a type of a clip connection.

FIG. 2 shows a cutout of a one-part wheel 1 with a rim 2, which is formed in one piece with the wheel spokes 3. The outer rim base 9 consists of a rim shoulder 26, which passes into a transition section 27, which is followed by an outer rim flange 28, wherein the outside end of the outer rim flange 28 in turn features a groove 29.

A rim-flange protection ring 20 is in turn composed of a first journal 21 and a second journal 22, along with a fastening element 23. The fastening of the rim-flange protection ring 20 to the outer rim base 9 is effected by means of a clip connection, wherein the fastening element 23 works in conjunction with a lock washer 24, which is attached to the outer side of the rim shoulder 26.

Between the rim-flange protection ring 20 and the outer rim base 9, a cavity 72 is formed, which extends in both an axial and a radial direction. A balancing weight 6 is arranged in the cavity 72.

FIG. 3 shows the cross-section of the area of an outer rim base 9 for a two-part wheel 1. The outer rim base exhibits a rim shoulder 36, which follows a transition section 37, which finally passes into an outer rim flange 38. At its outside end, the outer rim flange 38 features a groove 39, in which a rim-flange protection ring 30 engages with a journal 31.

In the cross-section, the rim protection ring 30 is constructed in an L-shaped manner and is nearly at right angles. An additional journal 32 runs spaced from and essentially parallel to the rim shoulder 36. At its free end, the journal 32 is introduced and therein clamped in a gap 35 between rim 2 and wheel spokes 3. The rim-flange protection ring 30 is additionally secured by a notch 33 at the end of the journal 32. Between the outer rim base 9 and the rim-flange protection ring 30, a cavity 73 formed, which is suitable, for example, for incorporating balancing weights 6.

FIG. 4 shows a cross-section of a two-part wheel 1. The outer rim base 9 features a rim shoulder 46, which passes into a transition section 47, which in turn follows an outer rim flange 48. At the outside end of the outer rim flange 48, there is a groove 49 to support a rim protection ring 40.

In the cross-section, the rim-flange protection ring 40 is constructed in an L-shaped manner and is nearly at right angles from a first journal 41 and a second journal 42. The rim base 9 exhibits a ring 44, which is incorporated in a groove 45 into the outer side of the rim base 9 and works together with a corresponding, circulating nose 43 of the journal 42. Thus, the rim-flange protection ring 40 rests between wheel spokes 3 and outer rim base 9; an additional guide is achieved through the engagement of the journal 42 with its free end into a guiding groove 5 on the transition of the rim 2 to the wheel spokes 3. Thus, between the outer side of the rim base 9 and the rim-flange protection ring 40, an axial cavity 74 essentially arises, in which, in the present case, an automatic element 6 is attached.

FIG. 5 shows a cross-section of a cutout of a wheel 1. The outer rim base 9 in turn features a rim shoulder 56 and a transition section 57, which follows an outer rim flange 58 with a groove 59. In the sectional view, a rim-flange protection ring 50 with two journals 51, 52 is constructed in an L-shaped manner and is nearly at right angles, wherein the journal 52 rests outside on the rim shoulder 56 and is secured by means of a glue layer 53. Between the journal 51 and the opposite section of the outer rim base 9, a cavity 75 is formed, into which, in the present case, a balancing weight 6 is attached.

FIG. 6 shows a cross-section of an additional embodiment of the wheel 1. The outer rim base 9 features a rim shoulder 66, which passes into a transition section 67 and ends in an outer rim flange 68.

On the outside end of the outer rim flange 68, there is a groove 69, into which the rim-flange protection ring 60 engages. In the sectional view, the rim-flange protection ring 60 with journals 61, 62 is constructed in an L-shaped manner and is nearly at right angles, wherein the journal 62 rests closely against the outer side of the rim base 9 within the area of the rim shoulder 66. The securing takes place via fastening bolts 63. On the outer side, within the area of the outer rim flange 68, an axial cavity 76 is formed. In the present case, this cavity 76 is used to incorporate balancing weights 6.

In addition to these embodiments that are specified as examples, numerous additional possibilities are offered to the specialist for using thoughts of the invention. Thus, for example, types of fastening can be combined with one another, or the cavity 71, 72, 73, 74, 75, 76 can also be used for various engineered elements. Through the corresponding shaping of the outer rim base 9 and the rim-flange protection ring 10, 20, 30, 40, 50, 60, the geometry of the cavity 71, 72, 73, 74, 75, 76 can be varied to a great extent and the respective application purposes can be adapted.

Thereby, the rim-flange protection ring 10, 20, 30, 40, 50, 60 fulfills two functions. On the one hand, it is to protect the outer rim flange 18, 28, 38, 48, 58, 68 from damage; on the other hand, additionally engineered elements, which are provided in the area of the outer rim base 9, are to be enclosed.

Further possibilities of variation are available by the use of different materials for the rim-flange protection rings 10, 20, 30, 40, 50, 60. Thus, metals (such as, for example, titanium, aluminum, magnesium or high-grade steel) can be used, which can additionally be varied through coatings or other manipulations.

In addition to metals, plastics, fiber-reinforced plastics or composite materials can be used, the surfaces of which can likewise be treated. Likewise, natural materials (e.g., wood) are able to be used. Thus, the present invention offers numerous possibilities of changing and arranging the design of the wheels and, at the same time, ensuring the optimal protection of the outer rim flange 18, 28, 38, 48, 58, 68.

Moreover, the present invention offers the possibility of incorporating additional engineered elements, without which the visual impression of the wheel 1 suffers.

For simplification purposes, balancing weights 6 excluded in FIGS. 1 to 6 are presented as examples of such engineered elements. However, no restriction is to be seen in this, because it is obvious to the specialist that the cavity 71, 72, 73, 74, 75, 76 is likewise suitable for incorporating other engineered elements (e.g., the valve or a device for tire pressure control).

For the present invention, the form of the wheel 1 is of secondary importance. The rim-flange protection ring 10, 20, 30, 40, 50, 60 according to the invention can be used both for one-part and multiple-part wheels 1.

### REFERENCE LIST OF ALL DRAWINGS

1 wheel
2 rim
3 wheel spokes
4 inner rim flange
5 guiding groove
6 balancing weight
7 fastening bolt
8 inner rim base
9 outer rim base
10 rim-flange protection ring
11 journal
12 journal
13 fastening element
14 groove
15 recess
16 rim shoulder
17 transition section
18 outer rim flange
19 groove
20 rim-flange protection ring
21 journal
22 journal
23 fastening element
24 lock washer
26 rim shoulder
27 transition section
28 outer rim flange
29 groove
30 rim-flange protection ring
31 journal
32 journal
33 notch
35 gap
36 rim shoulder
37 transition section
38 outer rim flange
39 groove
40 rim-flange protection ring
41 journal
42 journal
43 nose
44 ring
45 groove
46 rim shoulder
47 transition section
48 outer rim flange
49 groove
50 rim-flange protection ring
51 journal
52 journal
53 glue layer
56 rim shoulder
57 transition section
58 outer rim flange
59 groove
60 rim-flange protection ring
61 journal
62 journal
63 fastening bolt
66 rim shoulder
67 transition section
68 outer rim flange
69 groove
71 cavity
72 cavity
73 cavity
74 cavity
75 cavity
76 cavity

1. Wheel (1), in particular a light-alloy wheel for motor vehicles, with an outer rim flange (18,28,38,48,58,68), exhibiting an outer rim base (9) and a rim-flange protection ring (10,20,30,40,50,60), characterized by the fact that, between the rim-flange protection ring (10,20,30,40,50,60) and the outer rim base (9), a cavity (71,72,73,74,75,76) is formed, into which engineered elements are able to be arranged.

2. Wheel (1) according to claim 1, characterized by the fact that the cavity (71,72,73,74,75,76) extends in an axial and/or radial direction and is preferably formed in the outer rim base (9) according to a type of an indentation, a shoulder, a recess or a channel (even rotating).

3. Wheel (1) according to claim 1, characterized by the fact that the cavity (71,72,73,74,75,76) is essentially closed.

4. Wheel (1) according to claim 1, characterized by the fact that the rim-flange protection ring (10,20,30,40,50,60) is essentially formed in an L-shaped manner in the cross-section.

5. Wheel (1) according to claim 1, characterized by the fact that the rim-flange protection ring (10,20,30,40,50) is provided with fastening elements (13, 23, 43), which are formed in one piece on the rim-flange protection ring (10,20,30,40,50) or are undetachably attached to the rim-flange protection ring.

6. Wheel (1) according to claim 5, characterized by the fact that the fastening element (13) engages in a groove (14), which is provided outside on the rim base (9).

7. Wheel (1) according to claim 5, characterized by the fact that the fastening element (23) works together with a lock washer (24), which is fastened outside on the outer rim base (9).

8. Wheel (1) according to claim 5, characterized by the fact that the fastening element is a circulating nose (43), which works together with a ring (44), which are held in a groove (45) on the outer side of the outer rim base (9).

9. Wheel (1) according to claim 1, characterized by the fact that the wheel (1) is a multiple-part wheel with a rim (2) and wheel spokes (3), and that the rim-flange protection ring (30) is clamped between the rim (2) and the wheel spokes (3).

10. Wheel (1) according to claim 1, characterized by the fact that the rim-flange protection ring (50) is secured by means of a layer of glue (53).

11. Wheel (1) according to claim 1, characterized by the fact that the rim-flange protection ring (60) is fastened by means of bolts.

12. Wheel (1) according to claim 1, characterized by the fact that the rim-flange protection ring (10,20,30,40,50,60) is made of a metal material selected from amongst the group of: high-grade steel, titanium, aluminum or magnesium.

13. Wheel (1) according to claim 1, characterized by the fact that the rim-flange protection ring (10,20,30,40,50,60) is made of carbon fiber-reinforced plastic or glass fiber-reinforced plastic.

14. Wheel (1) according to claim 1, characterized by the fact that the rim-flange protection ring (10,20,30,40,50,60) is made of a bonding material.

15. Wheel (1) according to claim 1, characterized by the fact that the rim-flange protection ring (10,20,30,40,50,60) is provided with a paint coating.

16. Wheel (1) according to claim 1, characterized by the fact that the rim-flange protection ring (10,20,30,40,50,60) features design elements, particularly in the form of bolt mockups distributed over the entire area according to a type of a bolt cross.

17. Wheel (1) according to claim 1, characterized by the fact that the engineered elements are balancing weights (6), valves or devices for tire pressure control.

18. A Wheel according to claim 1, characterized by the fact that the rim-flange protection ring is provided with a chrome coating.

19. A Wheel according to claim 1, characterized by the fact that the rim-flange protection ring is provided with a coating with nanoparticles.

20. A Wheel according to claim 19, characterized by the fact that the coating with nanoparticles comprises nano-alpha-aluminum oxide.
